(19) United States
(12) Patent Application Publication
(10) Pub. No.: US 2025/0139383 A1
(43) Pub. Date: May 1, 2025

(54) SYSTEMS AND METHODS FOR SOLVING MATHEMATICAL WORD PROBLEMS USING LARGE LANGUAGE MODELS

(71) Applicant: INTUIT INC., Mountain View, CA (US)

(72) Inventors: Anu SINGH, Mountain View, CA (US); Xiang GAO, Mountain View, CA (US); Kamalika DAS, Mountain View, CA (US)

(73) Assignee: INTUIT INC., Mountain View, CA (US)

(21) Appl. No.: 18/498,997

(22) Filed: Oct. 31, 2023

(51) Int. Cl. G06F 40/40; G06F 16/33

(52) U.S. Cl. CPC G06F 40/40; G06F 16/3331

(57) ABSTRACT

Systems and methods are provided for solving mathematical word problems using large language models.

### BACKGROUND OF THE DISCLOSURE

With the recent emergence of generative artificial intelligence (AI), there has been explosive growth in automating the creation of content, data, and models. The fast-paced research and development in the space of large language models (LLMs) has led to such growth. Some of the most prominent use cases of generative AI have been for content creation, augmentation, personalization, simulation and modeling, and enhancing human creativity. For example, many organizations may use LLMs within the question-and-answer (“QnA”) platforms provided to their users. For example, when users need assistance with a service (e.g., banking, accounting, taxes, shopping, etc.), they frequently will interact with a QnA platform (e.g., QnA search, chatbot, etc.), which enables the users to ask questions without having to talk to a human over the telephone.

In addition, LLMs (e.g., GPT-3/4, Falcon, PALM, LLama, etc.) typically use the most likely next token generation approach to generate “human-like” responses. However, while LLMs can provide valuable insights, they may not always deliver accurate results or reliable reasoning. LLMs tend to digress in their reasoning steps as they progress when attempting to solve a multi-step mathematical or logical problem, which is undesirable.

### BRIEF DESCRIPTION OF THE FIGURES

FIG. 1 is a block diagram of an example system for solving mathematical word problems using large language models according to example embodiments of the present disclosure.

FIG. 2 is a flowchart of an example process for solving mathematical word problems using large language models according to example embodiments of the present disclosure.

FIG. 3 is a flowchart of an example process for generating a final response according to example embodiments of the present disclosure.

FIGS. 4A and 4B show example few-shot training examples for use within the system of FIG. 1 according to some embodiments of the present disclosure.

FIG. 5 is an example server device that can be used within the system of FIG. 1 according to an embodiment of the present disclosure.

FIG. 6 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Despite the advancements in LLM capabilities, applying them through complex reasoning tasks still remains challenging. While navigating through the space of answer generation, an LLM can lose track of information it has already gathered and falter through its steps, leading to an incorrect response. Therefore, tracking the intermediate derivation steps that an LLM arrives at during response generation can provide more accurate results.

Embodiments of the present disclosure therefore relate to systems and methods for solving mathematical word problems using large language models. In some embodiments, the disclosed techniques can utilize a divide-and-conquer-based methodology to present an input query to an LLM in sub-steps and have the LLM solve the individual sub-steps, rather than the complete problem at one time. In some embodiments, the disclosed techniques constrain the search state space of reasoning for the LLM by limiting the information available to work with at each step. This approach can help reduce the possibilities of the LLM navigating in wrong directions when exploring the answer to an input query. For example, the disclosed systems and methods can, given a relatively complex problem, decompose the problem into multiple progressive sub-problems and prompt the LLM to solve the sub-problems individually, but based on the previous sub-problem's answer. In other words, the disclosed LLM can progressively apply compositional reasoning to generate a final response as an answer to the full original query based on the various answers to sub-problems that were generated.

An example of the disclosed decomposition techniques is illustrated below in Table 1.

TABLE 1

| | Decomposition and | |
|---|---|---|
| Input Problem | Solution | Final Answer |
| Toulouse has twice as | Sub-problem 1: How many | 260 sheep |
| many sheep as | sheep does Charleston | |
| Charleston. Charleston | have? | |
| has 4 times as many | If Seattle has 20 sheep, | |
| sheep as Seattle. How | Charleston has 4*20 sheep = | |
| many sheep do Toulouse, | 80 sheep. | |
| Charleston, and Seattle | Sub-problem 2: How many | |
| have together if Seattle | sheep does Toulouse | |
| has 20 sheep? | have? | |
| | Toulouse has twice as | |
| | many sheep as | |
| | Charleston, which is 2*80 | |
| | sheep = 160 sheep. | |
| | Sub-problem 3: How many | |
| | sheep do Toulouse, | |
| | Charleston, and Seattle | |
| | have together? | |
| | Together, the three have | |
| | 20 sheep + 160 sheep + | |
| | 80 sheep = 260 sheep. | |

The original input problem is “Toulouse has twice as many sheep as Charleston. Charleston has 4 times as many sheep as Seattle. How many sheep do Toulouse, Charleston, and Seattle have together if Seattle has 20 sheep?” The disclosed LLM decomposes the input problem into three sub-problems, answers the three sub-problems progressively, and ultimately arrives at the final answer of 260 sheep.

Therefore, the disclosed systems and methods can 1) perform problem decomposition into sub-problems; 2) progressively solve the sub-problems (forming sub-solutions); and 3) apply compositional reasoning over the sub-solutions to generate a final response. Directing an LLM to solve the input problem in pieces using the disclosed divide-and-conquer strategy can help reduce the possibilities of the LLM going in the wrong direction of reasoning and planning within the answer space.

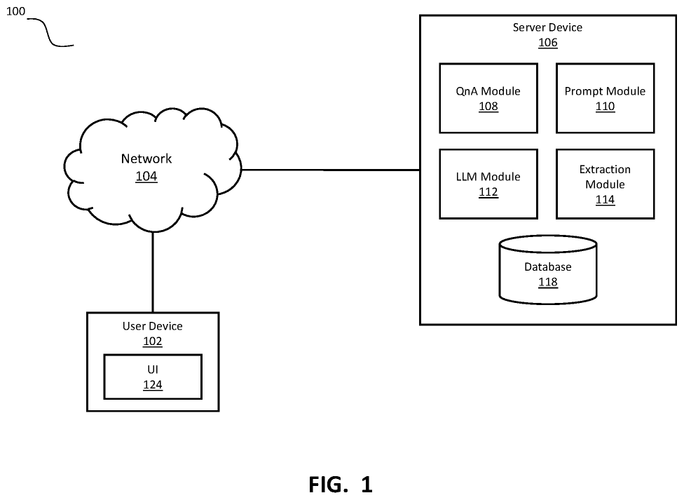

FIG. 1 is a block diagram of an example system 100 for solving mathematical word problems using large language models according to example embodiments of the present disclosure. The system can include one or more user devices 102 (generally referred to herein as a “user device 102” or collectively referred to herein as “user devices 102”) that can access, via network 104, a QnA module 108 residing on a server device 106. This communication link enables a user operating the user device 102 to interact with, via a user interface (UI) 124, the QnA module 108 such that he/she can ask questions that will automatically be answered, such as e.g., via a QnA platform or a chatbot. For example, the QnA module 108 could be a part of various online services, such as banking, taxes, shopping, and others. In some embodiments, the system 100 can include any number of user devices 102. For example, for a financial or accounting platform or other website that may offer services to users, there may be an extensive userbase with thousands or even millions of users that connect to the system 100 via their respective user device 102.

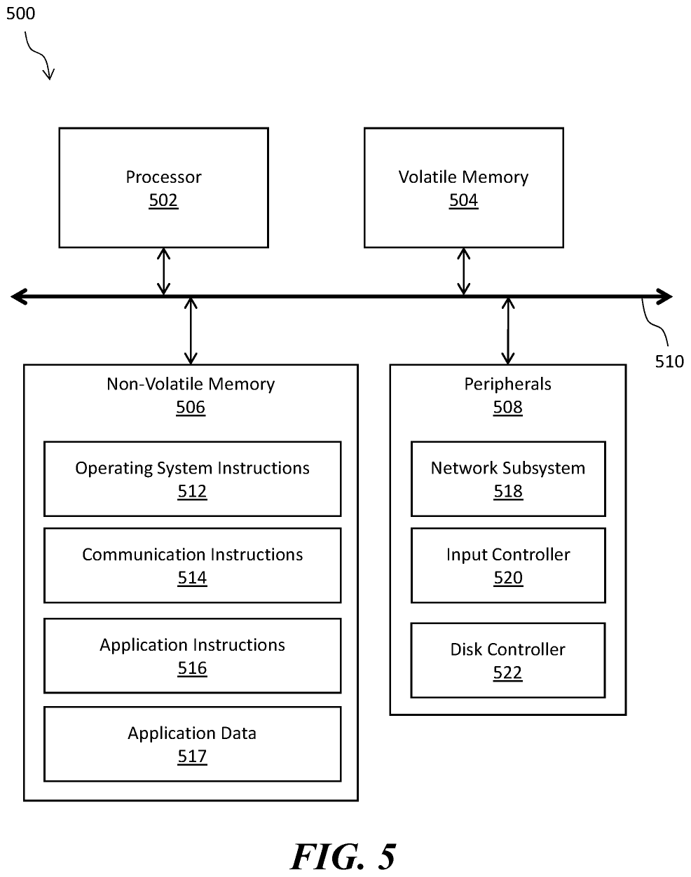

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, tablet, or other suitable device. In some embodiments, a user device 102 can be the same as or similar to the computing device 500 described below with respect to FIG. 5.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 500 described below in the context of FIG. 5.

As shown in FIG. 1, the server 106 can include a QnA module 108, a prompt module 110, an LLM module 112, an extraction module 114, and a database 118.

In some embodiments, the QnA module 108 is configured to execute a chatbot platform or other QnA platform that a user can interact with via user device 102. In some embodiments, when the chatbot is executing, a chat interface is displayed on the user device 102 via the UI 124, enabling the user to interact with the QnA module 108. In other embodiments, a search bar or other platform can be displayed to the user device 102 via the UI 124 that enables the user to interact with the QnA module 108. The QnA module 108 can receive a query entered into and submitted through the UI 124, which is transmitted to the QnA module 108 via the network 104. In addition, the QnA module 108 can be configured to transmit responses/answers generated in response to the user query back to the user device 102 for display in the UI 124.

In some embodiments, the prompt module 110 is configured is receive the user query received by the QnA module 108 and format the query into a prompt for the LLM module 112. In some embodiments, the prompt module 110 can retrieve a predefined few-shot prompt template from the database 118. The prompt module 110 can then use the received user query and the few-shot prompt template to generate an input prompt for the LLM module 112. The prompt can prompt the LLM module 112 to break down the original query into a plurality of sub-problems and progressively answer each sub-problem using the previous sub-problem answer.

In some embodiments, the LLM module 112 includes an LLM, such as GPT-3, -3.5, -4, PaLM, Ernie Bot, LLaMa, and others. In some embodiments, an LLM can include various transformed-based models trained on vast corpuses of data that utilize an underlying neural network. The LLM module 112 can receive an input, such as a user query from the QnA module 108. The LLM module 112 is configured to analyze the input and generate one or more additional QnA pairs that are similar to the input.

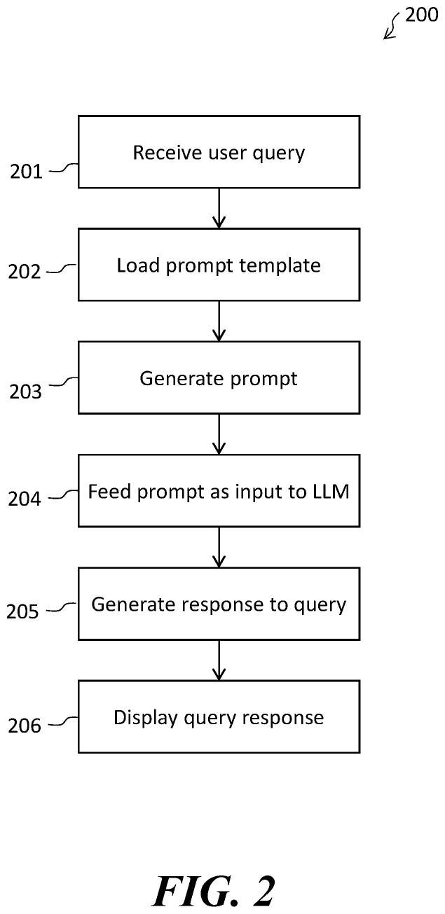

FIG. 2 is a flowchart of an example process 200 for solving mathematical word problems using large language models according to example embodiments of the present disclosure. In some embodiments, process 200 can be performed by the server 106 in conjunction with an ongoing communication between a user device 102 and the QnA module 108. For example, a user may have a chatbot interface or other QnA platform executing on the user device 102 via UI 124 where he/she will type a question in the chatbot interface.

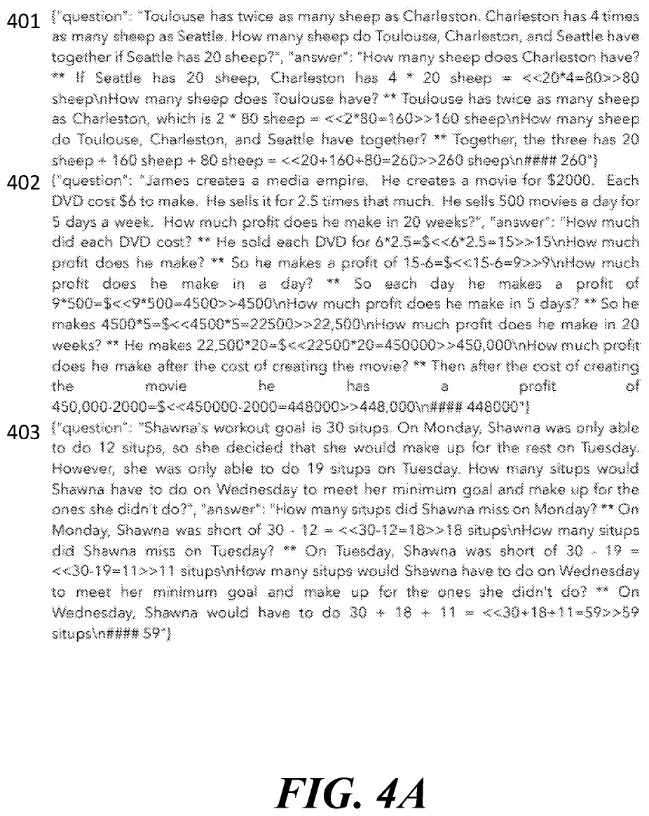

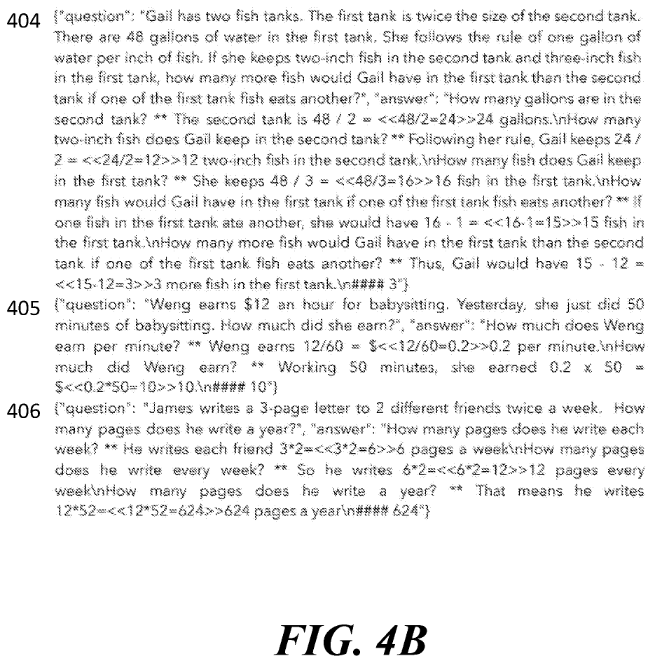

At block 201, the QnA module 108 receives a user query from a user device 102. For example, a user operating the user device 102 could be communicating with the QnA module 108 via a chatbot or other QnA platform via interface 124. The user can enter a query via a UI 124, which is transmitted over the network 104 and received by the QnA module 108. At block 202, the prompt module 110 loads a pre-defined prompt template. In some embodiments, this can include accessing the database 118 and retrieving the stored pre-defined prompt template. In some embodiments, the prompt template can include few-shot training examples that the LLM module 112 considers when generating its response to the query. In other words, the prompt template can include instructions that prompt the LLM module 112 to break down the received user query into a plurality of sub-problems and progressively answer each sub-problem using the previous answer. An example prompt template is shown in FIGS. 4A and 4B.

At block 204, the prompt module 110 feeds the prompt as an input to the LLM module 112. At block 205, the LLM module 112 generates a response to the original user query by analyzing the prompt. As discussed above, the prompt can include the original user query and various few-shot training examples of broken-down questions and answers (additional details are discussed below in relation to FIGS. 4A and 4B). The LLM module 112 can therefore generate a response to the user query based on the few-shot training examples in the prompt. In some embodiments, the response generated by the LLM module 112 can be formatted in the same manner as the few-shot training examples. At block 206, the response to the query generated by the LLM module 112 is displayed, such as e.g., to the user device 102. In some embodiments, displaying the query response to the user device 102 can include extracting a final answer from the generated output.

In some embodiments, as an alternative to displaying the query response to the user device 102, the method 200 can include alternate steps, such as extracting the final answer from the generated output and one or more of feeding the final answer to a subsequent stage of a pipeline to answer additional questions or for verification and training purposes.

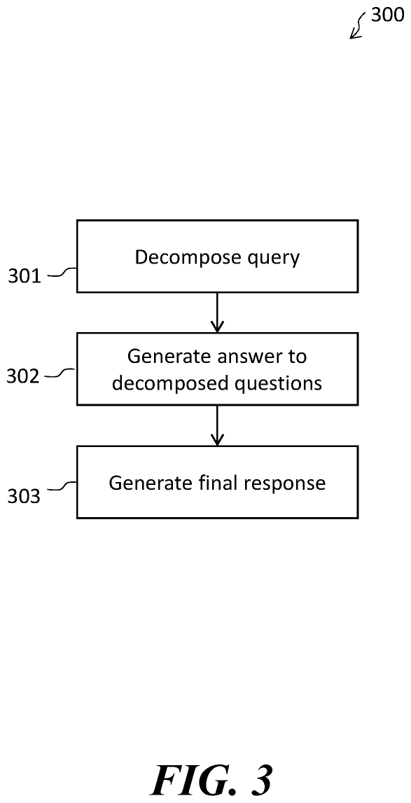

FIG. 3 is a flowchart of an example process 300 for generating a final response according to example embodiments of the present disclosure. In some embodiments, process 300 can be performed by the server 106 in conjunction with an ongoing communication between a user device 102 and the QnA module 108. For example, process 300 can be performed at block 205 of process 200 of FIG. 2. An example of the decomposed sub-problems and answers is shown in Table 1 above.

At block 301, the LLM module 112 decomposes the user query into a plurality of sub-problems. For example, the LLM module 112 can decompose the user query into a plurality of sub-problems based on a few-shot training prompt template that was fed in as part of the initial input prompt. At block 302, the LLM module 112 generates an answer to the decomposed sub-problems. For example, the LLM module 112 can generate a first answer to a first sub-problem. Then, the LLM module generates, based on the first answer, a second answer to a second sub-problem. The LLM module 112 can continue in this manner until a final answer is achieved at block 303. In this manner, the information in which the LLM module 112 accesses to answer each sub-problem is restricted, providing for a better retention of detail across different sub-problems in a complex overall problem.

FIGS. 4A and 4B show example few-shot training examples 401-406 for use within the system of FIG. 1 according to some embodiments of the present disclosure. In some embodiments, the few-shot training examples 401-406 can be contained in a single predefined prompt template, such as the one retrieved and utilized by the prompt module 110 (see block 202 of FIG. 2). Each of the few-shot training examples 401-406 includes an original question defined as “question.” In addition, each of the few-shot training examples 401-406 includes a plurality of sub-problems and answers as the “answer.” Finally, each few-shot training example can include a final answer at the end of the prompt that can be extracted by various post-processing techniques.

FIG. 5 is a diagram of an example server device 500 that can be used within system 100 of FIG. 1. Server device 500 can implement various features and processes as described herein. Server device 500 can be implemented on any electronic device that runs software applications derived from complied instructions, including without limitation personal computers, servers, smart phones, media players, electronic tablets, game consoles, email devices, etc. In some implementations, server device 500 can include one or more processors 502, volatile memory 504, non-volatile memory 506, and one or more peripherals 508. These components can be interconnected by one or more computer buses 510.

Processor(s) 502 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 510 can be any known internal or external bus technology, including but not limited to ISA, EISA, PCI, PCI Express, USB, Serial ATA, or FireWire. Volatile memory 504 can include, for example, SDRAM. Processor 502 can receive instructions and data from a read-only memory or a random access memory or both. Essential elements of a computer can include a processor for executing instructions and one or more memories for storing instructions and data.

Non-volatile memory 506 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 506 can store various computer instructions including operating system instructions 512, communication instructions 514, application instructions 516, and application data 517. Operating system instructions 512 can include instructions for implementing an operating system (e.g., Mac OS®, Windows®, or Linux). The operating system can be multi-user, multiprocessing, multitasking, multithreading, real-time, and the like. Communication instructions 514 can include network communications instructions, for example, software for implementing communication protocols, such as TCP/IP, HTTP, Ethernet, telephony, etc. Application instructions 516 can include instructions for various applications. Application data 517 can include data corresponding to the applications.

Peripherals 508 can be included within server device 500 or operatively coupled to communicate with server device 500. Peripherals 508 can include, for example, network subsystem 518, input controller 520, and disk controller 522. Network subsystem 518 can include, for example, an Ethernet of WiFi adapter. Input controller 520 can be any known input device technology, including but not limited to a keyboard (including a virtual keyboard), mouse, track ball, and touch-sensitive pad or display. Disk controller 522 can include one or more mass storage devices for storing data files; such devices include magnetic disks, such as internal hard disks and removable disks; magneto-optical disks; and optical disks.

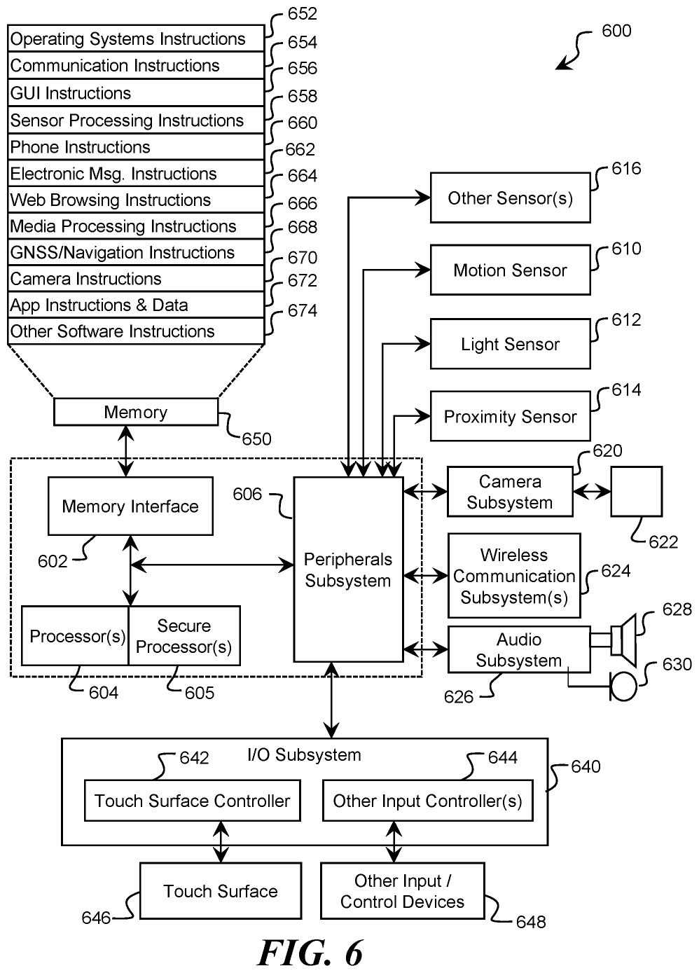

FIG. 6 is an example computing device that can be used within the system 100 of FIG. 1, according to an embodiment of the present disclosure. In some embodiments, device 600 can be user device 102. The illustrative user device 600 can include a memory interface 602, one or more data processors, image processors, central processing units 604, and or secure processing units 605, and peripherals subsystem 606. Memory interface 602, one or more central processing units 604 and or secure processing units 605, and or peripherals subsystem 606 can be separate components or can be integrated in one or more integrated circuits. The various components in user device 600 can be coupled by one or more communication buses or signal lines.

Sensors, devices, and subsystems can be coupled to peripherals subsystem 606 to facilitate multiple functionalities. For example, motion sensor 610, light sensor 612, and proximity sensor 614 can be coupled to peripherals subsystem 606 to facilitate orientation, lighting, and proximity functions. Other sensors 616 can also be connected to peripherals subsystem 606, such as a global navigation satellite system (GNSS) (e.g., GPS receiver), a temperature sensor, a biometric sensor, magnetometer, or other sensing device, to facilitate related functionalities.

Camera subsystem 620 and optical sensor 622, e.g., a charged coupled device (CCD) or a complementary metal-oxide semiconductor (CMOS) optical sensor, can be utilized to facilitate camera functions, such as recording photographs and video clips. Camera subsystem 620 and optical sensor 622 can be used to collect images of a user to be used during authentication of a user, e.g., by performing facial recognition analysis.

Communication functions can be facilitated through one or more wired and or wireless communication subsystems 624, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 624. The specific design and implementation of communication subsystems 624 can depend on the communication network(s) over which the user device 600 is intended to operate. For example, user device 600 can include communication subsystems 624 designed to operate over a GSM network, a GPRS network, an EDGE network, a WiFi or WiMax network, and a Bluetooth™ network. For example, wireless communication subsystems 624 can include hosting protocols such that device 600 can be configured as a base station for other wireless devices and or to provide a WiFi service.

Audio subsystem 626 can be coupled to speaker 628 and microphone 630 to facilitate voice-enabled functions, such as speaker recognition, voice replication, digital recording, and telephony functions. Audio subsystem 626 can be configured to facilitate processing voice commands, voice-printing, and voice authentication, for example.

I/O subsystem 640 can include a touch-surface controller 642 and or other input controller(s) 644. Touch-surface controller 642 can be coupled to a touch-surface 646. Touch-surface 646 and touch-surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 646.

The other input controller(s) 644 can be coupled to other input/control devices 648, such as one or more buttons, rocker switches, thumb-wheel, infrared port, USB port, and or a pointer device such as a stylus. The one or more buttons (not shown) can include an up/down button for volume control of speaker 628 and or microphone 630.

In some implementations, a pressing of the button for a first duration can disengage a lock of touch-surface 646; and a pressing of the button for a second duration that is longer than the first duration can turn power to user device 600 on or off. Pressing the button for a third duration can activate a voice control, or voice command, module that enables the user to speak commands into microphone 630 to cause the device to execute the spoken command. The user can customize a functionality of one or more of the buttons. Touch-surface 646 can, for example, also be used to implement virtual or soft buttons and or a keyboard.

In some implementations, user device 600 can present recorded audio and or video files, such as MP3, AAC, and MPEG files. In some implementations, user device 600 can include the functionality of an MP3 player, such as an iPod™. User device 600 can, therefore, include a 36-pin connector and or 8-pin connector that is compatible with the iPod. Other input/output and control devices can also be used.

Memory interface 602 can be coupled to memory 650. Memory 650 can include high-speed random access memory and or non-volatile memory, such as one or more magnetic disk storage devices, one or more optical storage devices, and or flash memory (e.g., NAND, NOR). Memory 650 can store an operating system 652, such as Darwin, RTXC, LINUX, UNIX, OS X, Windows, or an embedded operating system such as VxWorks.

Operating system 652 can include instructions for handling basic system services and for performing hardware dependent tasks. In some implementations, operating system 652 can be a kernel (e.g., UNIX kernel). In some implementations, operating system 652 can include instructions for performing voice authentication.

Memory 650 can also store communication instructions 654 to facilitate communicating with one or more additional devices, one or more computers and or one or more servers. Memory 650 can include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic messaging-related process and functions; web browsing instructions 664 to facilitate web browsing-related processes and functions; media processing instructions 666 to facilitate media processing-related functions and processes; GNSS/Navigation instructions 668 to facilitate GNSS and navigation-related processes and instructions; and or camera instructions 670 to facilitate camera-related processes and functions.

Memory 650 can store application (or “app”) instructions and data 672, such as instructions for the apps described above in the context of FIGS. 1-4. Memory 650 can also store other software instructions 674 for various other software applications in place on device 600. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computing system comprising:
a processor; and
a non-transitory computer-readable storage device storing computer-executable instructions, the instructions operable to cause the processor to perform operations comprising:
receiving a query from a user device;
loading a prompt template from a database, the prompt template comprising instructions for decomposing the query into a plurality of sub-problems;
generating a prompt with the query and the prompt template;
feeding the prompt as an input to a large language model (LLM);
generating a response to the query via the LLM; and
transmitting the generated response to the user device.

2. The computing system of claim 1, wherein receiving the query from the user device comprises receiving a message from a chatbot interface.

3. The computing system of claim 1, wherein receiving the query from the user device comprises receiving a message from a question-and-answer search interface.

4. The computing system of claim 1, wherein the instructions comprise a plurality of few-shot training examples that instruct the LLM to generate the response to the query.

5. The computing system of claim 4, wherein each of the few-shot training examples comprises a question example and an answer example, the answer example comprising a plurality of example sub-problems.

6. The computing system of claim 5, wherein each of the few-shot training examples comprises an example final answer format.

7. The computing system of claim 1, wherein generating the response to the query comprises:
decomposing the query into the plurality of sub-problems;
generating an answer to each of the plurality of sub-problems; and
generating the response to the query based on the generated answers.

8. The computing system of claim 7, wherein generating the answers to each of the plurality of sub-problems comprises:
generating a first answer to a first sub-problem; and
generating a second answer to a second sub-problem based on the first answer.

9. The computing system of claim 7, wherein generated the response to the query based on the generated answers comprises extracting a final answer.

10. The computing system of claim 9, wherein the operations further comprise feeding the extracted final answer to a subsequent stage of a pipeline.

11. A computer-implemented method, performed by at least one processor, comprising:
receiving a query from a user device;
loading a prompt template from a database, the prompt template comprising instructions for decomposing the query into a plurality of sub-problems;
generating a prompt with the query and the prompt template;
feeding the prompt as an input to a large language model (LLM);
generating a response to the query via the LLM; and
transmitting the generated response to the user device.

12. The computer-implemented method of claim 11, wherein receiving the query from the user device comprises receiving a message from a chatbot interface.

13. The computer-implemented method of claim 11, wherein receiving the query from the user device comprises receiving a message from a question-and-answer search interface.

14. The computer-implemented method of claim 11, wherein the instructions comprise a plurality of few-shot training examples that instruct the LLM to generate the response to the query.

15. The computer-implemented method of claim 14, wherein each of the few-shot training examples comprises a question example and an answer example, the answer example comprising a plurality of example sub-problems.

16. The computer-implemented method of claim 15, wherein each of the few-shot training examples comprises an example final answer format.

17. The computer-implemented method of claim 11, wherein generating the response to the query comprises:
decomposing the query into the plurality of sub-problems;
generating an answer to each of the plurality of sub-problems; and
generating the response to the query based on the generated answers.

18. The computer-implemented method of claim 17, wherein generating the answers to each of the plurality of sub-problems comprises:
generating a first answer to a first sub-problem; and
generating a second answer to a second sub-problem based on the first answer.

19. The computer-implemented method of claim 17, wherein generated the response to the query based on the generated answers comprises extracting a final answer.

20. The computer-implemented method of claim 19 comprising feeding the extracted final answer to a subsequent stage of a pipeline.
